(19) United States
(12) Patent Application Publication
(10) Pub. No.: US 2007/0172400 A1
(43) Pub. Date: Jul. 26, 2007

(54) CHEMICAL REACTOR AND FUEL CELL SYSTEM

(76) Inventors: Hideo Kitamura, Yokohama-shi (JP); Yoshiyuki Isozaki, Tokyo (JP); Masahiro Kuwata, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/534,001

(22) Filed: Sep. 21, 2006

(30) Foreign Application Priority Data
Jan. 24, 2006 (JP) 2006-015233

(51) Int. Cl. B01J 8/00

(52) U.S. Cl. 422/189; 429/19; 48/61

(57) ABSTRACT

There is proposed a chemical reactor comprising a vessel for housing an organic raw material having a higher saturated vapor pressure than atmospheric pressure, a reformer for reforming at least a portion of the organic raw material into a reformed gas, an inlet flow channel to which the vessel is removably attached, enabling the vessel to be communicated with the reformer, and an inlet port side cut-off valve disposed in the inlet flow channel and designed to be brought into an open state as the vessel is attached, thus permitting the organic raw material to pass through the inlet flow channel, and brought into a closed state as the vessel is removed from the inlet flow channel, thus cutting off the inlet flow channel.

### CROSS-REFERENCE TO RELATED APPLICATIONS

This application is based upon and claims the benefit of priority from prior Japanese Patent Application No. 2006-015233, filed Jan. 24, 2006, the entire contents of which are incorporated herein by reference.

### BACKGROUND OF THE INVENTION

1. Field of the Invention

This invention relates to a chemical reactor and a fuel cell system.

2. Description of the Related Art

In recent years, there has been an increasing expectation for the development of a fuel cell system using hydrogen and an ultramicro-gas turbine system which are considered useful as a small power source for portable electronic instruments for supporting the information society.

As for the fuel to be employed in these systems, dimethyl ether is especially considered promising. Dimethyl ether can be easily liquefied. Since the saturated vapor pressure of dimethyl ether at ordinary temperature, once it is liquefied, is about 6 atm, which is much higher than atmospheric pressure, dimethyl ether can be transported to a fuel cell unit or to an ultramicro-gas turbine system without necessitating a pump and hence the employment of dimethyl ether is advantageous in this respect. Further, if dimethyl ether is to be applied to these systems, it is required to reform dimethyl ether into a hydrogen-containing gas by making use of a conversion means. The employment of dimethyl ether is also advantageous in the respects that it can be reformed at a lower temperature as compared with natural gas and that it is free from sulfur content.

In the actual use of these small power sources, depending on the environments of use or on the manner of handling them, they may suffer a severe shock if the body of this power source is accidentally dropped. When the connection between a vessel housing the fuel and a power source main body is damaged or when the vessel is disconnected from the power source main body due to such a severe shock, the sealing performance of the power source may be damaged, possibly permitting the substance contained in the power source main body or in the vessel to leak therefrom into the atmosphere.

For example, JPA 2004-119193 (KOKAI) (hereinafter referred to as patent document 1) discloses a fuel cell system which is provided with an inlet side cutoff valve which is designed to inhibit a fuel gas stored in the fuel cell from counter-flowing from a fuel gas inlet port when the pressure of fuel gas in a fuel gas supply passageway is caused to become lower than a set pressure. This inlet side cutoff valve is constructed such that a check valve is opened by the feeding pressure of fuel gas to feed the fuel gas to the fuel gas inlet port of fuel cell. Incidentally, in the case of the fuel cell system of Document 1, a hydrogen-containing gas is employed as a fuel gas.

However, according to the fuel cell system of the patent document 1, it is impossible to sufficiently inhibit the leak-out of fuel gas to the atmosphere from the interior of the system. Especially in the case of the power source main body of the fuel cell system of the type where a reformed gas is employed, not only the hydrogen gas generated from the reforming reaction is permitted to leave as it is or in an unreacted state but also carbon monoxide is allowed to exist as a reaction by-product. Because of these reasons, it is desired to completely prevent the leakage of gas containing these substances.

JPA 11-125346 (1999) (KOKAI) discloses a liquefied natural gas supply system provided with a low pressure cutoff valve, wherein the pressure therein is designed to be lowered if an accident or problem occurs, thereby causing the low pressure cutoff valve to automatically close, thus cutting off the supply of liquefied natural gas, the low pressure cutoff valve being subsequently permitted to open after the restoration of safety has been confirmed.

Further, JPA 2004-183713 (KOKAI) discloses an on-off valve for a fuel cell, which is designed to prevent the recirculation of excessive hydrogen gas in hydrogen purging as well as the discharging of newly generated hydrogen to the external atmosphere, thus reliably carrying out the hydrogen purging, and to prevent the wasting of newly generated hydrogen. This on-off valve is brought into a closed state by feeding a compressed air, etc., acting as a pilot pressure, to this on-off valve.

### BRIEF SUMMARY OF THE INVENTION

An object of the present invention is to provide a chemical reactor and a fuel cell system, which are capable of inhibiting the leakage of unreacted gas as well as the leakage of a gas containing a by-product.

According to one aspect of the present invention, there is provided a chemical reactor comprising: a vessel for housing an organic raw material having a higher saturated vapor pressure than atmospheric pressure; a reformer for reforming at least a portion of the organic raw material into a reformed gas; an inlet flow channel to which the vessel is removably attached, enabling the vessel to be communicated with the reformer; and an inlet port side cut-off valve disposed in the inlet flow channel and designed to be brought into an open state as the vessel is attached, thus permitting the organic raw material to pass through the inlet flow channel, and brought into a closed state as the vessel is removed, thus cutting off inlet flow channel.

According to a second aspect of the present invention, there is provided a chemical reactor comprising: a vessel for housing an organic raw material having a higher saturated vapor pressure than atmospheric pressure; a reformer for reforming at least a portion of the organic raw material into a reformed gas; an inlet flow channel to which the vessel is removably attached, enabling the vessel to be communicated with the reformer; and an inlet port side cut-off valve disposed in the inlet flow channel and designed to be brought into an open state as the pressure in the inlet flow channel becomes the same as or higher than a predetermined pressure, thus permitting the organic raw material to pass through the inlet flow channel, and brought into a closed state as the pressure in the inlet flow channel becomes lower than said predetermined pressure, thus cutting off the inlet flow channel.

According to a third aspect of the present invention, there is provided a fuel cell system comprising: a vessel for housing an organic raw material having a higher saturated vapor pressure than atmospheric pressure; a reformer for reforming at least a portion of the organic raw material into a reformed gas, the reformer comprising a vaporization section for vaporizing the organic raw material, a reforming section for reforming the organic raw material thus vaporized into a hydrogen-containing gas, and a carbon monoxide-removing section for removing at least a portion of carbon monoxide included in the hydrogen-containing gas; an inlet flow channel to which the vessel is removably attached, enabling the vessel to be communicated with the reformer, the inlet flow channel being disposed on the inlet port side of the reformer; a cut-off valve disposed in the inlet flow channel and designed to be brought into an open state as the vessel is attached, thus permitting the organic raw material to pass through the inlet flow channel, and brought into a closed state as the vessel is removed, thus cutting off inlet flow channel; a fuel cell unit for generating electrical energy by making use of the hydrogen-containing gas having said at least a portion of carbon monoxide removed therefrom and air including oxygen; and a combustion device for burning at least a portion of exhaust gas discharged from the fuel cell unit.

According to a fourth aspect of the present invention, there is provided a fuel cell system comprising: a vessel for housing an organic raw material having a higher saturated vapor pressure than atmospheric pressure; a reformer constituted by a vaporization section for vaporizing the organic raw material, by a reforming section for reforming the organic raw material thus vaporized into a hydrogen-containing gas, and by a carbon monoxide-removing section for removing at least a portion of carbon monoxide included in the hydrogen-containing gas; an inlet flow channel to which the vessel is removably attached, enabling the vessel to be communicated with the reformer; a cut-off valve disposed in the inlet flow channel and designed to be brought into an open state as the pressure in the inlet flow channel becomes the same with or higher than a predetermined pressure, thus permitting the organic raw material to pass through the inlet flow channel, and brought into a closed state as the pressure in the inlet flow channel becomes lower than said predetermined pressure, thus cutting off inlet flow channel; a fuel cell unit for generating electrical energy by making use of the hydrogen-containing gas having said at least a portion of carbon monoxide removed therefrom and air including oxygen; and a combustion device for burning at least a portion of exhaust gas discharged from the fuel cell unit.

### BRIEF DESCRIPTION OF THE SEVERAL VIEWS OF THE DRAWING

FIG. 1 is a block diagram illustrating the construction of the fuel cell system according to a first embodiment;

FIGS. 2A and 2B respectively show a schematic cross-sectional view illustrating the inlet port side cut-off valve (single-flow type cut-off valve) of the fuel cell system according to the first embodiment;

FIG. 3 is a block diagram illustrating the construction of the fuel cell system according to a second embodiment;

FIGS. 4A and 4B respectively show a schematic cross-sectional view illustrating the outlet port side cut-off valve (dividing flow type cut-off valve) of the fuel cell system according to the second embodiment;

FIG. 5 is a block diagram illustrating the construction of the fuel cell system according to a third embodiment;

FIG. 6 is a block diagram illustrating the construction of the fuel cell system according to a fourth embodiment;

FIG. 7 is a block diagram illustrating the construction of the fuel cell system according to a fifth embodiment;

FIG. 8 is a block diagram illustrating the construction of the fuel cell system according to a sixth embodiment;

FIG. 9 is a block diagram illustrating the construction of the fuel cell system according to a seventh embodiment;

FIG. 10 is a block diagram illustrating the construction of the modified ultramicro-gas turbine system according to an eighth embodiment;

FIG. 11 is a block diagram illustrating the construction of the fuel cell system according to a ninth embodiment; and

FIG. 12 is a block diagram illustrating the construction of the modified gas turbine system according to a tenth embodiment.

### DETAILED DESCRIPTION OF THE INVENTION

Next, various embodiments of the present invention will be illustrated with reference to drawings.

Herein, the chemical reactors illustrated in these embodiments of the present invention may be any of a fuel cell system, a modified ultramicro-gas turbine system, an analyzing system, and a modified gas turbine system.

### First Embodiment

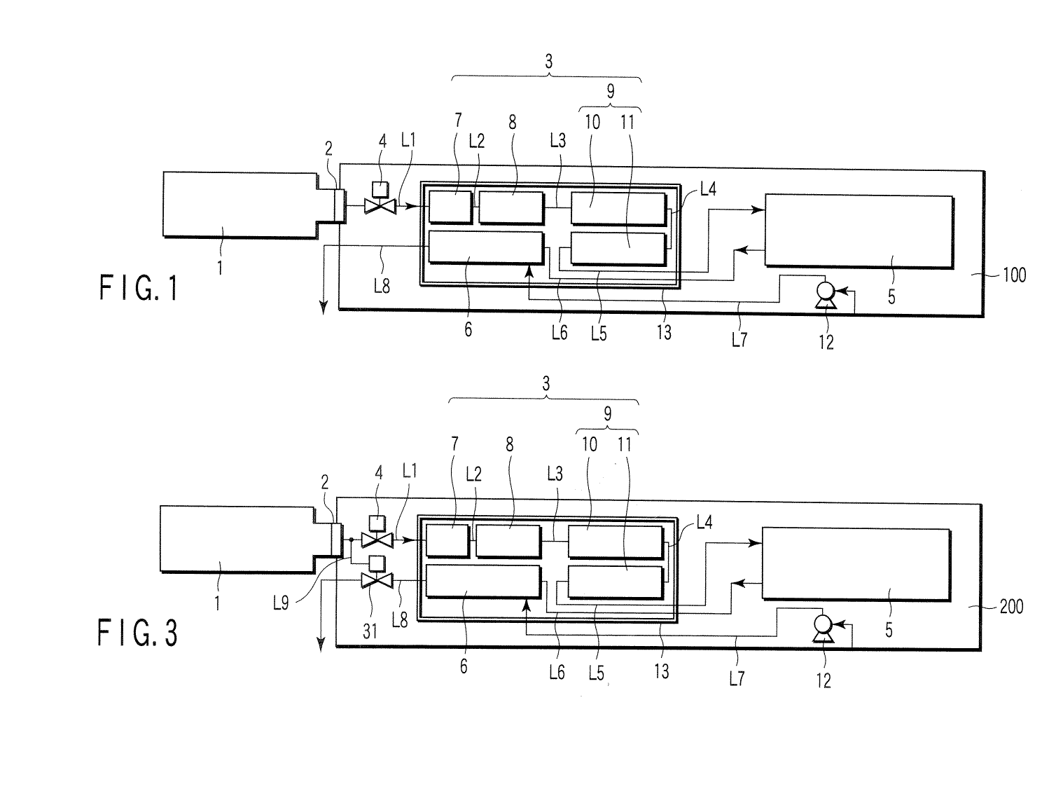

The fuel cell system according to the first embodiment of the present invention will be explained with reference to FIG. 1. This fuel cell system comprises a system main body 100, a fuel vessel 1, and a connecting portion 2 for removably connecting the fuel vessel 1 with the system main body 100. This system main body 100 is equipped with a reformer 3, an inlet side cut-off valve 4, a fuel cell unit 5 acting as a reformer, and a combustion equipment 6. The reformer 3 is constituted by a vaporizing section 7, a reforming section 8 and a CO-removing section 9. This CO-removing section 9 is constituted by a CO-shifting section 10 and a methanation section 11. The combustion equipment 6 is connected with an air pump 12.

The fuel vessel 1 is removably connected, via the connecting portion 2, with a pipe line (hereinafter referred to as an inlet port line L1) communicated with the inlet port side of the vaporizing section 7. The fuel vessel 1 is filled with, as a fuel for the fuel cell unit 5, an organic raw material (hereinafter referred to simply as fuel) having a higher saturated vapor pressure than atmospheric pressure. This fuel may be a mixture of dimethyl ether and water. The fuel vessel 1 may be formed of a pressure vessel equipped with a bayonet-type coupler connecting portion which can be removably and hermetically connected with the connecting portion 2 of system main body 100. For example, when the connecting portion of the fuel vessel 1 is forcedly inserted into the connecting portion 2 of system main body 100, the valve stem of the fuel vessel 1 is caused to advance with the rib portion thereof being guided along a guiding groove. As a result, the valve of the system main body 100 is pulled away from the valve seat resisting against the urging force of the spring which is biased to push the valve of the system main body 100 toward the valve seat, thus enabling the flow channel of fuel vessel 1 to communicate with the inlet port line L1 without generating the leakage of liquid.

The liquefied dimethyl ether has a saturated vapor pressure (absolute pressure) of about 6 atm at ordinary temperature, which is higher than atmospheric pressure. As a result, by utilization of the pressure of dimethyl ether, the fuel can be delivered from the fuel vessel 1 to the vaporizing section 7, to be explained hereinafter. On this occasion, dimethyl ether and water can be individually delivered from separate vessels (not shown), and then combined and mixed with each other at a portion located upstream of the vaporizing section 7 or in the vaporizing section 7. Alternatively, it is also possible to deliver dimethyl ether and water as a mixture from a single vessel. In any case, the mixing ratio between dimethyl ether (DME) and water should preferably be confined to the range of 1:3 to 1:4 in mole ratio (DME:water). When the mixing ratio between dimethyl ether and water is confined to this range, not only the supply of fuel can be performed smoothly but also the power-generating efficiency can be enhanced.

In the case where dimethyl ether and water are delivered as a mixture, the compatibility between dimethyl ether and water can be enhanced by adding methanol to the mixture in advance, thereby making the liquid phase in the fuel vessel 1 become a homogeneous phase. In this case, the mixing ratio of methanol should preferably be confined to the range of 5 to 10% by weight based on the mixture of dimethyl ether and water. When mixing ratio of methanol is confined to this range, not only the compatibility between dimethyl ether and water can be remarkably enhanced, but also smooth supply of fuel can be realized. Even when methanol is added in this manner, the saturated vapor pressure of the mixture consisting of dimethyl ether, water and methanol can be made higher than atmospheric pressure, thus making it possible to obtain a pressure ranging from 3 to 5 atm at room temperature, for instance.

The fuel to be employed in the present invention is not limited to those described above, but may be a mixture consisting of a liquefied gas and water where the saturated vapor pressure thereof can be made higher than atmospheric pressure. Examples of such a liquefied gas include, other than dimethyl ether, propane, isobutene, normal butane, etc. All of these liquefied gases have a saturated vapor pressure which is higher than atmospheric pressure at ordinary temperature. Further, it is also possible to employ a liquefied gas whose saturated vapor pressure is higher than atmospheric pressure at temperatures higher than ordinary temperature. Examples of such a liquefied gas include methanol, ethanol, etc. When these liquefied gases are to be employed, heating means (not shown) may be included in the fuel cell system. As in the case of dimethyl ether, these liquefied gases may be mixed with water in the fuel vessel 1, or may be mixed with water at a portion located upstream of the vaporizing section 7 or in the vaporizing section 7. These liquefied gases may be used singly or in combination of two or more kinds. In the following description, embodiments where dimethyl ether is used as a liquefied gas will be explained. It should be noted however that almost the same effects can be obtained even if other kinds of liquefied gases are employed. Incidentally, these fuels may be in a state of liquid or in a mixed state of gas/liquid in the fuel vessel 1 as well as in each section of the system main body 100 of the fuel cell.

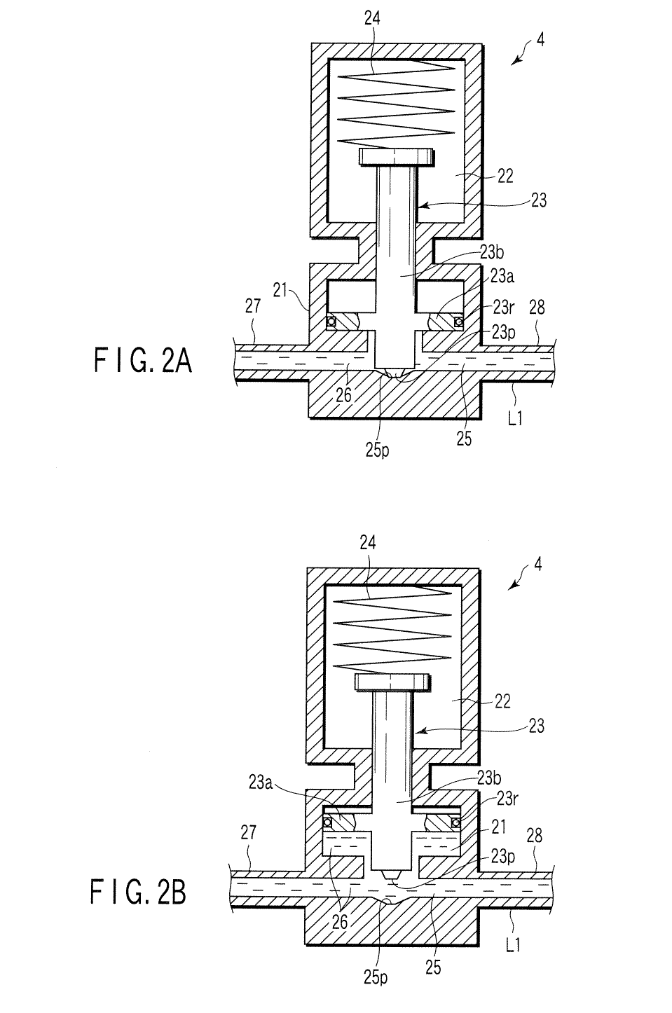

The inlet side cut-off valve 4 is attached to the inlet port line L1 which is communicated with the vaporizing section 7. A fuel is delivered from the fuel vessel 1, via the inlet side cut-off valve 4 and the inlet port line L1, to the vaporizing section 7. Since the pressure inside the inlet port line L1 is made higher than a predetermined pressure, i.e. due to the effects of the pressure of fuel which is higher than atmospheric pressure, the inlet side cut-off valve 4 is brought into an open state. This inlet side cut-off valve 4 will be further explained in detail as follows with reference to FIGS. 2A and 2B.

FIGS. 2A and 2B show respectively a schematic cross-sectional view of the inlet side cut-off valve shown in FIG. 1. In the following description, the cut-off valve having a structure shown in FIGS. 2A and 2B will be referred to as “single-flow type cut-off valve”.

The single-flow type cut-off valve 4 is provided with a pressure-actuating chamber 21 which is communicated with the flow channel 25 of the inlet port line L1, with an urging force application chamber 22 equipped with a compressed spring 24, and with a valve 23 equipped with a partitioning wall 23a and a valve rod 23b. The partitioning wall 23a is attached to a location near the distal end of the valve rod 23b. The partitioning wall 23a is installed inside the pressure-actuating chamber 21 so as to partition the interior of the pressure-actuating chamber 21. The partitioning wall 23a is provided, on the outer peripheral wall thereof, with a groove, in which an O-ring 23r is fitted. Since the O-ring 23r is contacted with the inner wall of the pressure-actuating chamber 21, the flow channel 25 is sealed externally, thus preventing the fuel 26 of the flow channel 25 from leaking out of the flow channel 25.

The rear end portion of the valve 23 is positioned inside the urging force application chamber 22. The compressed spring 24 is installed inside the urging force application chamber 22. Due to the effect of this compressed spring 24, the valve 23 is urged, with a predetermined force, toward the pressure-actuating chamber 21.

The interior of the pressure-actuating chamber 21 is partitioned by the partitioning wall 23a of valve. As shown in FIG. 2A, when the inlet port line L1 is not mounted on the main body 100, the distal end portion 23p of valve is caused to fit in the recessed portion 25p of flow channel by the urging force of the spring 24, thus cutting off the flow channel 25 of the inlet port line L1. This state of the inlet side cut-off valve 4 is referred to as a closed state. On the other hand, as shown in FIG. 2B, when the inlet port line L1 is mounted on the main body 100, due to the pressure of fuel from the vessel 1, the valve 23 is pushed upward resisting against the urging force of the spring 24, thus opening the flow channel 25 of the inlet port line L1. This state of the inlet side cut-off valve 4 is referred to as an opened state.

The fuel 26 is permitted to flow from the fuel vessel 1, via the connecting portion 2, into the flow channel 25 of the inlet port line L1 and then introduced, via the flow channel 25 of the inlet side 27, into the inlet side cut-off valve 4, thus pushing up the valve 23 and enabling the fuel 26 to flow from the flow channel 25 of the inlet side 27 to the flow channel 25 of the outlet side 28. The fuel 26 to be introduced into the flow channel 25 is made higher in pressure (about 6 atm in the case of DME) than atmospheric pressure. In this case, due to the effect of the pressure of fuel on the partitioning wall 23a, the valve 23 is caused to move, resisting against the urging force of the spring 24, toward the urging force application chamber 22. In this manner, when the fuel vessel 1 is mounted on the system main body 100, the fuel 26 is permitted to flow into the flow channel 25 of inlet side cut-off valve 4 and transferred to the vaporizing section 7.

On the other hand, when the fuel vessel 1 happens to be disconnected from the system main body 100 of fuel cell due to a shock, etc., the supply of fuel 26 is stopped, thus lowering the pressure of the pressure-actuating chamber 21 (a space between the partitioning wall 23a and the flow channel 25). When the inner pressure of the pressure-actuating chamber 21 becomes lower than a predetermined pressure (i.e. a pressure which can be determined by the sliding resistance of valve 23 due to the urging force of the spring 24, the area of partitioning wall and the friction of valve 23), the valve 23 is caused to move due to the effect of the spring 24, thus cutting off the flow channel 25.

The spring 24 may be formed of various kinds of spring such as a coil spring, a leaf spring, an air spring, etc. When the spring 24 is formed of a coil spring, the spring constant “k” per unit area of the partitioning wall 23a should preferably be confined to the range of 0.007 N/mm³ to 0.7 N/mm³ if a fuel to be supplied is formed of a mixture consisting of dimethyl ether, water and methanol. The spring constant “k” per unit area of the partitioning wall 23a should preferably be confined to the range of 0.01 N/mm³ to 1 N/mm³ if a fuel to be supplied is formed of only dimethyl ether.

The fuel 26 is heated and vaporized in the vaporizing section 7. This vaporizing section 7 is connected, via a pipe line L2, with the reforming section 8. The vaporized fuel is transferred from the vaporizing section 7 into the reforming section 8, in which the vaporized fuel is reformed into a gas containing hydrogen (reformed gas). The reforming section 8 is provided therein with a plurality of inner passageways for passing the vaporized fuel therethrough. These passageways carry, on the inner walls thereof, a catalyst for promoting the reforming reaction of fuel.

The reforming section 8 is connected via a pipe line L3 with the CO shifting section 10. The reformed gas thus obtained contains, in addition to hydrogen (H₂), by-products such as carbon dioxide (CO₂) and carbon monoxide (CO). The presence of carbon monoxide would become a cause for deteriorating the anode catalyst of fuel cell unit 5 to be explained hereinafter or a cause for deteriorating the power generating performance of the system main body 100 of fuel cell. Therefore, prior to the transfer of the reformed gas to the fuel cell unit 5, the reformed gas is transferred from the reforming section 8 to the CO shifting section 10, in which the carbon monoxide (CO) is converted into carbon dioxide (CO₂) and hydrogen (H₂), thereby minimizing the quantity of carbon monoxide in the reformed gas and, at the same time, increasing the quantity of hydrogen. The CO shifting section 10 is provided therein with a plurality of inner passageways for passing the reformed gas therethrough. These passageways carry, on the inner walls thereof, a shift catalyst for promoting the shift reaction of carbon monoxide.

The CO shifting section 10 is connected via a pipe line L4 with the methanation section 11. The reformed gas that has been shifted in the CO shifting section 10 and transferred to the methanation section 11 still contains about 1% to 2% of carbon monoxide (CO). As described above, the presence of carbon monoxide would become a cause for deteriorating the power generating performance of the fuel cell system. Therefore, prior to the transfer of the reformed gas to the fuel cell unit 5, the reformed gas is transferred from the CO shifting section 10 to the methanation section 11, in which the carbon monoxide (CO) is converted, through methanation reaction, into methane (CH₄) and water, thereby eliminating carbon monoxide in the reformed gas or sufficiently minimizing the quantity of carbon monoxide in the reformed gas. The methanation section 11 is provided therein with a plurality of inner passageways for passing the reformed gas therethrough. These passageways carry, on the inner walls thereof, a methanation catalyst for promoting the methanation reaction of carbon monoxide included in the reformed gas.

The methanation section 11 is connected via a pipe line L5 with the fuel cell unit 5. The reformed gas (hydrogen-containing gas) from which carbon monoxide has been eliminated is transferred to the fuel cell unit 5. In this fuel cell unit 5, a chemical reaction between the hydrogen in the reformed gas and the oxygen in the air atmosphere is permitted to proceed. As a result of this chemical reaction, water is caused to generate and, at the same time, the generation of electrical energy is executed.

The fuel cell unit 5 is connected via a pipe line L6 with the combustion device 6. In this fuel cell unit 5, although hydrogen is reacted with oxygen to generate water, the exhaust gas from the fuel cell unit 5 contains unreacted hydrogen (H₂) and methane (CH₄). In the combustion device 6, these unreacted hydrogen and methane are burned by making use of the oxygen in air and catalytic effects. Specifically, by making use of the air pump 12, this air is fed to the combustion device 6 through a line L7 which is communicated with an external atmosphere outside the system main body 100. The combustion device 6 is provided therein with a plurality of inner passageways for passing the exhaust gas therethrough. These passageways carry, on the inner walls thereof, a catalyst for promoting the combustion reaction of the exhaust gas.

It is preferable in this case to utilize the combustion heat generated in the combustion for the heating of mainly the vaporizing section 7 and/or the reforming section 8. In order to transfer the combustion heat generated in the combustion device 6 to at least either one of the vaporizing section 7 and the reforming section 8, it is preferable to integrally cover the combustion device 6 and at least either one of the vaporizing section 7 and the reforming section 8 with an insulating member 13. Especially, in order to enhance the efficiency of heating and to protect parts which are low in heat resistance such as peripheral electronic circuits, it is preferable to cover the circumferences of parts such as the vaporizing section 7, the reforming section 8, the CO shifting section 10, the methanation section 11 and the combustion device 6 with the insulating member 13.

Thereafter, the exhaust gas delivered from the combustion device 6 is discharged out of the fuel cell system through an outlet pipe (hereinafter, referred to as an outlet line L8) attached to the combustion device 6.

In this fuel cell system, when the pressure acting on the inlet side cut-off valve 4 is decreased below a predetermined pressure, the inlet side cut-off valve 4 is caused to close. Therefore, for example, if the connecting portion 2 is damaged or the fuel vessel 1 is disconnected from the system main body 100 due to a shock, etc. given to the system main body 100, the inlet side cut-off valve 4 is immediately brought into a closed state. Because of this, it is possible to prevent the counter-flow of the gas containing by-products such as carbon monoxide that may exist in the reforming section 8 or in a post stage of the reforming section 8 as well as the counter-flow of unreacted gas containing hydrogen, thereby reliably preventing the leakage or diffusion of these gases out of the fuel cell system and hence enhancing the safety of the fuel cell system. Further, even on the occasion of exchanging the fuel vessel 1 in the normal use thereof, it is possible to reliably prevent the leakage of the aforementioned gases from the inlet port line L1. Moreover, since it is no longer necessitated to separately provide an auxiliary equipment for feeding a high-pressure gas for bringing the cut-off valve 4 into an open state, it is possible to miniaturize the fuel cell system.

Incidentally, in contrast to the conventional fuel cell system of the aforementioned patent document 1 wherein the pressure of fuel gas is utilized, since the fuel cell system according to this embodiment utilizes, as a pressurizing source, a liquefied gas whose saturated vapor pressure at ordinary temperature is higher than atmospheric pressure or a mixture of the liquefied gas and water, it is possible to more reliably close the cut-off valve. Namely, the liquefied gas and a mixture thereof, both designed to be employed in the fuel cell system of this embodiment, are higher in saturated vapor pressure at ordinary temperature as compared with that of the fuel gas to be employed in the aforementioned patent document 1. Because of this, it is possible, according to the fuel cell system of this embodiment, to employ a spring (urging means) having a higher spring constant than that of the conventional fuel cell system disclosed in the aforementioned patent document 1. As a result, it is possible, according to the fuel cell system of this embodiment, to close the flow channel more quickly and reliably when the supply of pressure is cut off, thereby making it possible to more reliably prevent the leakage of gases out of the fuel cell system.

Additionally, the cut-off valve of this embodiment no longer necessitates the employment of a mechanism to be driven by the supply of electric current as in the case of the conventional cut-off valve disclosed in the aforementioned patent document 1, so that even if the supply of pressure is cut off, there is less possibility that the pressure of the liquefied gas or a mixture thereof existing inside the cut-off valve is increased. Namely, according to this embodiment, it is possible to omit the mechanism to minimize the loss of pressure in the cut-off valve as seen in the aforementioned patent document.

Incidentally, even when the fuel vessel 1 is disconnected, the catalytic combustion reaction is permitted to continue due to the operation of the air pump 12. Therefore, according to the fuel cell system shown in FIG. 1, it is possible to prevent the hydrogen-containing gas that has been discharged from the fuel cell unit 5 from leaking and diffusing out of the fuel cell system through the outlet port line L8.

### Second Embodiment

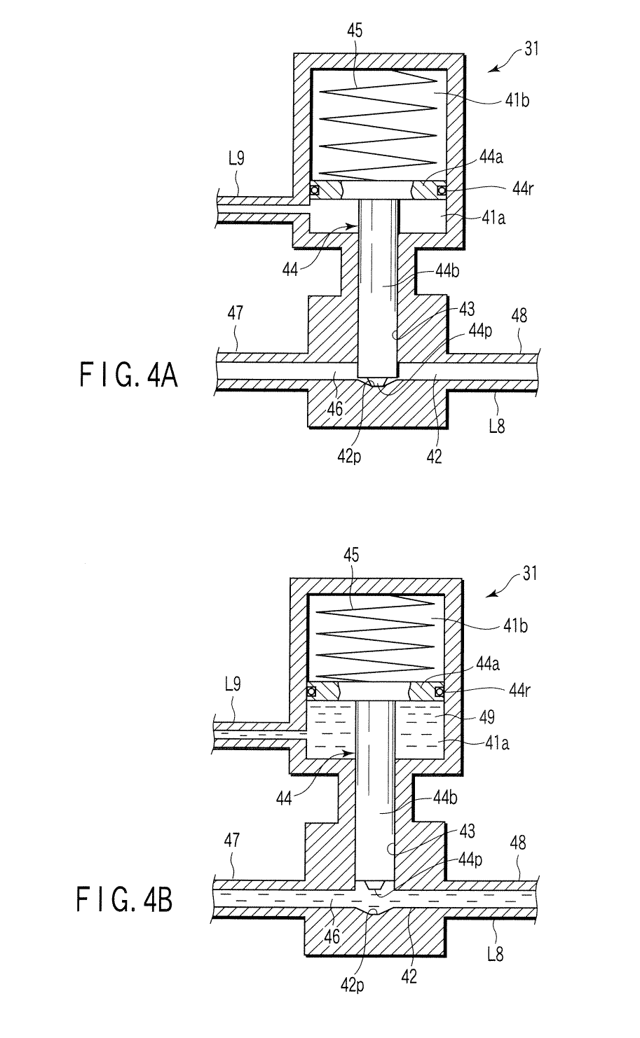

Next, a fuel cell system according to the second embodiment of the present invention will be explained with reference to FIGS. 3, 4A and 4B. Incidentally, with respect to the components or parts of this embodiment which overlap with those of the first embodiment, the explanations thereof will be omitted in the following description.

As shown in FIG. 3, the fuel cell system according to the second embodiment is featured in that an outlet side cut-off valve 31 is additionally mounted on the fuel cell system of the aforementioned first embodiment. This outlet side cut-off valve 31 is attached to the outlet line L8 which is employed for discharging the exhaust gas from the combustion device 6 out of the fuel cell system main body 200. The exhaust gas generated in the combustion device 6 is discharged out of the fuel cell system through the outlet side cut-off valve 31. Due to the effect of the pressure of fuel, which is higher than atmospheric pressure on the pressure-actuating chamber 41a, the outlet side cut-off valve 31 is brought into an open state. This outlet side cut-off valve 31 will be further explained in detail as follows with reference to FIGS. 4A and 4B.

FIGS. 4A and 4B show respectively a schematic cross-sectional view of the outlet side cut-off valve shown in FIG. 3. In the following description, the cut-off valve having a structure shown in FIGS. 4A and 4B will be referred to as “dividing-flow type cut-off valve”.

The outlet side cut-off valve 31 is provided with a pressure-actuating chamber 41a, with a slide guide 43, with a valve 44 equipped with a partitioning wall 44a and a valve rod 44b, and with an urging force-applying chamber 41b having a compressed spring 45. The valve rod 44b is inserted into the slide guide 43 and made slidable in the axial direction thereof. The valve 44 is urged toward the flow channel 42 of the outlet line L8 by the effect of the spring 45 disposed inside the urging force-applying chamber 41b. The partitioning wall 44a is installed to partition the pressure-actuating chamber 41a from the urging force-applying chamber 41b. The space inside the pressure-actuating chamber 41a is communicated, via a line L9, with the fuel vessel 1 or with the inlet port line L1. The partitioning wall 44a is provided, on the outer peripheral wall thereof, with a groove, in which an O-ring 44r is fitted. Since the O-ring 44r contacts the inner wall of the chambers 41a and 41b, the flow channel of the line L9 and the space of the pressure-actuating chamber 41a are hermetically separated from the urging force-applying chamber 41b, thus preventing the fuel 49 from leaking out of the fuel cell system.

When the spring 45 is expanded, a distal end portion 44p of valve is pressed into a recessed portion 42p of the flow channel, thereby closing the flow channel 42 of the outlet port line L8. FIG. 4A shows a closed state of the cut-off valve 31. When the spring 45 is shrunk, the distal end portion 44p of valve is moved away from the recessed portion 42p of the flow channel, thereby opening the flow channel 42 of the outlet port line L8. FIG. 4B shows an opened state of the cut-off valve 31. Incidentally, the spring 45 may be formed of the same type of coil-like compression spring as employed in the inlet side cut-off valve 4.

The exhaust gas 46 delivered from the combustion device 6 is introduced, via the flow channel 42 of the exhaust gas inlet port 47 into the cut-off valve 31. Thereafter, the exhaust gas is discharged from the exhaust gas outlet port 48 of the flow channel 42. Incidentally, the exhaust gas 46 introduced into the flow channel 42 may not necessarily be higher in pressure than atmospheric pressure.

On the other hand, the pressure of fuel 49 is considerably higher than atmospheric pressure. When the fuel vessel 1 is mounted on the system main body 200, fuel 49 is introduced directly into the pressure-actuating chamber 41a or diverged from the inlet port line L1 and then introduced, via the line L9, into the pressure-actuating chamber 41a. The line L9 acts as a flow channel for introducing fuel 49 into the pressure-actuating chamber 41a of cut-off valve 31. Due to the pressure of the fuel 49, the partitioning wall 44a is caused to move, resisting against the urging force of the spring 45, toward the urging force-applying chamber 41b. As a result, the distal end portion 44p of the valve is moved away from the recessed portion 42p, thus enabling the flow channel 42 of exhaust gas inlet port 47 side to communicate with the flow channel 42 of exhaust gas outlet port 48 side, thereby permitting the exhaust gas 46 to discharge, via the flow channel 42, out of the fuel cell system.

Incidentally, when the fuel vessel 1 is disconnected from the system main body 200 due to the effect of shock, etc., the fuel 49 is prevented from being introduced into the pressure-actuating chamber 41a, thus lowering the inner pressure of the pressure-actuating chamber 41a. When the inner pressure of the pressure-actuating chamber 41a is lower than a predetermined pressure, the valve 44 is pressed downward by the effect of the spring 45 to cut off the flow channel 42. Herein, the term “predetermined pressure” means a pressure which balances with a total force of the urging force of the spring 45, and the sliding resistance of the partitioning wall 44a or the valve rod 44b. The urging force of the spring 45 is determined as the spring coefficient which is inherent to the spring. The sliding resistance of the partitioning wall 44a is determined by the contacting area and friction coefficient between the inner walls of the chambers 41a and 41b and the outer peripheral surface of the partitioning wall 44a. Further, the sliding resistance of the valve rod 44b is determined by the contacting area and friction coefficient between the slide guide 43 and the valve rod 44b.

In the fuel cell system of this embodiment, when the pressure acting on the pressure-actuating chamber 41a is lower than a predetermined pressure, the cut-off valve 31 is immediately caused to close. For example, when the connecting portion 2 is damaged or when the fuel vessel 1 is disconnected from the system main body 200 due to a shock, etc. given to the system main body 200 or to the fuel vessel 1, the cut-off valve 31 is immediately brought into a closed state. Because of this, even when the pressure is lowered and the air pump 12 goes out of order due to shock, etc., or even when the temperature of the combustion device 6 is lowered, it is possible to completely prevent the hydrogen-containing gas that has been delivered from the fuel cell unit 5 from leaking or diffusing out of the fuel cell system. Moreover, since it is no longer necessitated to separately provide an auxiliary equipment for feeding a high-pressure gas for bringing the cut-off valve 31 into an open state, it is possible to miniaturize the fuel cell system.

Incidentally, depending on the structure of the air pump 12 and when the air pump 12 goes out of order, the hydrogen-containing gas that has been delivered from the combustion device 6 located on the downstream side of the air pump 12 may gradually back-flow through the line L7. In that case, it is preferable, in order to prevent the back-flow, to further install a dividing-flow type cut-off valve as shown in FIGS. 4A and 4B on the upstream or downstream side of the air pump 12 of the line L7.

### Third Embodiment

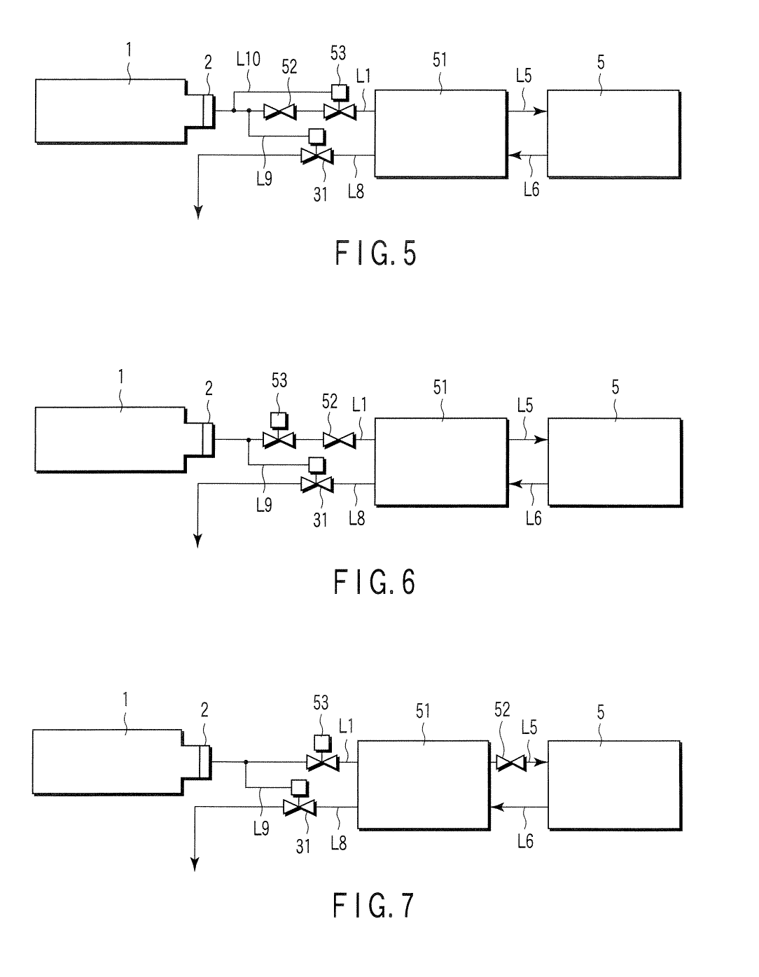

Next, a fuel cell system according to the third embodiment of the present invention will be explained with reference to FIG. 5. Incidentally, with respect to the components or parts of this embodiment which overlap with those of the above-described embodiments, the explanations thereof will be omitted in the following description.

The dividing-flow type cut-off valve shown in FIGS. 4A and 4B can be used not only in the outlet port side flow channel but also in the inlet port side flow channel. In the fuel cell system of this embodiment, a dividing-flow type cut-off valve is employed as an inlet side cut-off valve. In FIG. 5, the reforming unit 51 is an integral body comprising, as shown in FIGS. 1 and 3, a vaporizing section 7, a reforming section 8, a CO shifting section 10, a methanation section 11, a combustion device 6, and, if required, a heat-insulating member 13.

In the fuel cell system according to the third embodiment, a control valve 52 for controlling the flow rate of the fuel to be fed to the reforming unit 51 is installed in the inlet port line L1. This control valve 52 is employed for controlling the quantity of power generation at the fuel cell unit 5 through the adjustment in quantity of fuel supply. An inlet side cut-off valve 53 is installed in the line L1 disposed between the control valve 52 and the reforming unit 51. In this case, since the pressure of fuel decrease at a channel portion located on the downstream side of the control valve 52, the inlet side cut-off valve 53 having the same structure as that of the dividing-flow type cut-off valve 31 as shown in FIGS. 4A and 4B can be employed. Namely, fuel is introduced into the pressure-actuating chamber 41a directly from the fuel vessel 1 or introduced, via the line L9 which is diverged from a portion of the inlet port line L1 which is located upstream of the control valve 52, into the pressure-actuating chamber 41a. On the other hand, the fuel whose quantity has been by the control valve 52 is permitted to pass through the flow channel of the line L1.

As for the outlet side cut-off valve 31 of this fuel cell system, the construction thereof may be the same as that of the fuel cell system of FIG. 3 except that the line L9 is communicated with a channel portion located upstream of the fuel vessel 1 or of the control valve 52 of the line L1. Namely, in the fuel cell system of this embodiment, the pressure of fuel on the upstream side of the control valve 52 is made higher than atmospheric pressure, and, due to the effect of this high pressure of fuel, the inlet side cut-off valve 53 and the outlet side cut-off valve 31 are respectively brought into an opened state.

As for the control valve 52, it may be formed of any kind of conventional structure such as an orifice, a needle valve, a bellows valve, a diaphragm valve, a butterfly valve, etc. In addition to these structures, it is also possible employ a valve formed of a combination of orifices differing in configuration from each other, and a temperature-variable orifice which is capable of regulating the temperature of fluid to thereby change the viscosity of the fluid for controlling the flow rate thereof.

Incidentally, in the fuel cell system where the control valve 52 is not employed, the inlet side cut-off valve 53 may be formed of a dividing-flow type cut-off valve.

### Fourth Embodiment

Next, a fuel cell system according to the fourth embodiment of the present invention will be explained with reference to FIG. 6. Incidentally, with respect to the components or parts of this embodiment which overlap with those of the above-described embodiments, the explanations thereof will be omitted in the following description.

The fuel cell system according to the fourth embodiment is constructed in the same manner as the system of the above-described third embodiment except that the control valve 52 is installed at a region of the line L1 which is located between the inlet side cut-off valve 53 and the reforming unit 51. In this case, since the pressure of fuel to be fed to the inlet side cut-off valve 53 is sufficiently high, the inlet side cut-off valve 53 may be formed of the single-flow type cut-off valve as shown in FIGS. 2A and 2B or formed of the dividing-flow type cut-off valve as shown in FIGS. 4A and 4B. In the fuel cell system shown in FIG. 6, the single-flow type cut-off valve is employed for the inlet side cut-off valve 53.

On the other hand, since the pressure of exhaust gas to be discharged from the reforming unit 51 is close to that of atmospheric pressure, it is preferable to employ the dividing-flow type cut-off valve as the outlet side cut-off valve 31 and to diverge the line L9 from a region of the line L1 which is located upstream of the control valve 52.

### Fifth Embodiment

Next, a fuel cell system according to the fifth embodiment of the present invention will be explained with reference to FIG. 7. Incidentally, with respect to the components or parts of this embodiment which overlap with those of the above-described embodiments, the explanations thereof will be omitted in the following description.

The fuel cell system according to the fifth embodiment is constructed in the same manner as the system of the above-described third embodiment shown in FIG. 5 except that the control valve 52 is installed at a region of the line L5 which is located between the reforming unit 51 and the fuel cell unit 5. Therefore, the reforming unit 51 is made higher in pressure, thus making it possible to make the system more compact in configuration. In this case, since the pressure of fuel to be fed to the inlet side cut-off valve 53 is sufficiently high, the inlet side cut-off valve 53 may be formed of the single-flow type cut-off valve as shown in FIGS. 2A and 2B or formed of the dividing-flow type cut-off valve as shown in FIGS. 4A and 4B. In this fuel cell system shown in FIG. 7, the single-flow type cut-off valve is employed for the inlet side cut-off valve 53.

### Sixth Embodiment

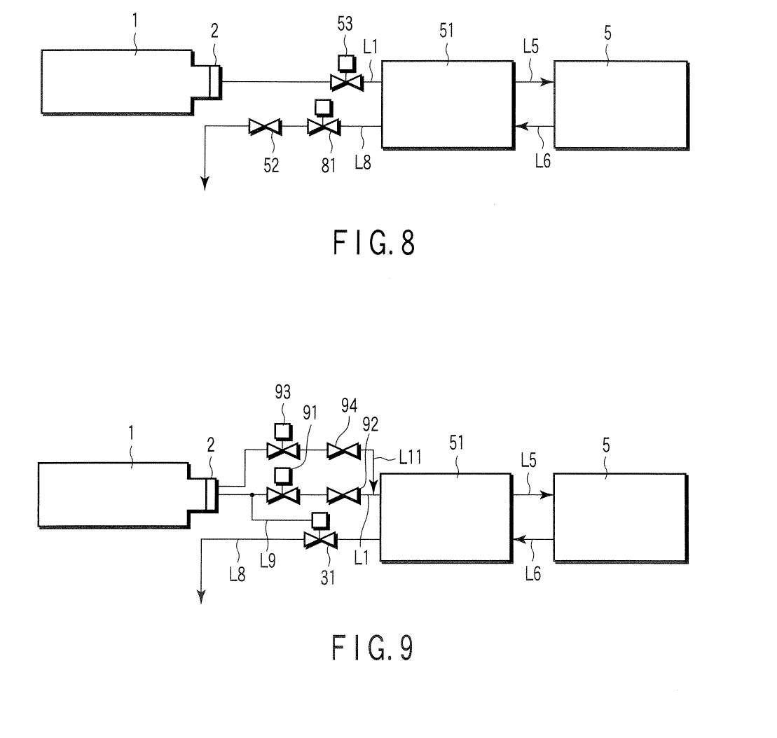

Next, a fuel cell system according to the sixth embodiment of the present invention will be explained with reference to FIG. 8. Incidentally, with respect to the components or parts of this embodiment which overlap with those of the above-described embodiments, the explanations thereof will be omitted in the following description.

The fuel cell system according to the sixth embodiment is constructed in the same manner as the system of the above-described third embodiment shown in FIG. 5 except that the control valve 52 is installed on the downstream side of the outlet side cut-off valve 81 which is installed in the line L8. Therefore, the reforming unit 51 and the fuel cell unit 5 are made higher in pressure, thus making it possible to make the system more compact in configuration.

In this case, since the pressure of exhaust gas to be discharged from the reforming unit 51 is sufficiently high, the outlet side cut-off valve 81 may be formed of the single-flow type cut-off valve as shown in FIGS. 2A and 2B or formed of the dividing-flow type cut-off valve as shown in FIGS. 4A and 4B. In this fuel cell system shown in FIG. 8, the single-flow type cut-off valve is employed for the outlet side cut-off valve 81.

### Seventh Embodiment

In the fuel cell systems of aforementioned first to sixth embodiments, dimethyl ether and water are mixed together in advance in the fuel vessel before they are fed to the fuel cell system. In this embodiment, dimethyl ether and water are individually fed to the fuel cell system and then mixed together at a region located on the upstream side of the reforming unit 51 as explained below.

The fuel cell system according to the seventh embodiment of the present invention will be explained with reference to FIG. 9. Incidentally, with respect to the components or parts of this embodiment which overlap with those of the above-described embodiments, the explanations thereof will be omitted in the following description.

In the case of the fuel cell system according to the seventh embodiment, dimethyl ether and water are separately stored, and the water is designed to be compressed by making the most of the saturated vapor pressure of dimethyl ether. Dimethyl ether is fed, via the line L1, to the reforming unit 51. In this line L1, an inlet side cut-off valve 91 for DME is installed. Further, a control valve 92 is installed at a channel portion of the line L1 which is located between the inlet side cut-off valve 91 and the reforming unit 51. On the other hand, water is fed from the fuel vessel 1, via the line L11, to the fuel cell system. This line L11 is joined with a channel portion of the line L1 which is located on the downstream side of the control valve 92. An inlet side cut-off valve 93 for water is installed in the line L11. Further, a control valve 94 is installed at a channel portion of the line L11 which is located on the downstream side of the inlet side cut-off valve 93. Since the pressures of the fluids to be fed to the inlet side cut-off valves 91 and 93 are both higher than atmospheric pressure, the inlet side cut-off valves 91 and 93 may be formed of either the single-flow type cut-off valve or the dividing-flow type cut-off valve. In this fuel cell system shown in FIG. 9, the single-flow type cut-off valve is employed for both of the outlet side cut-off valves 91 and 93.

On the other hand, since the pressure of exhaust gas to be discharged from the reforming unit 51 is close to that of atmospheric pressure, it is preferable to employ the dividing-flow type cut-off valve as the outlet side cut-off valve 31 and to diverge the line L9 from a region of the line L1 which is located upstream of the control valve 52.

### Eighth Embodiment

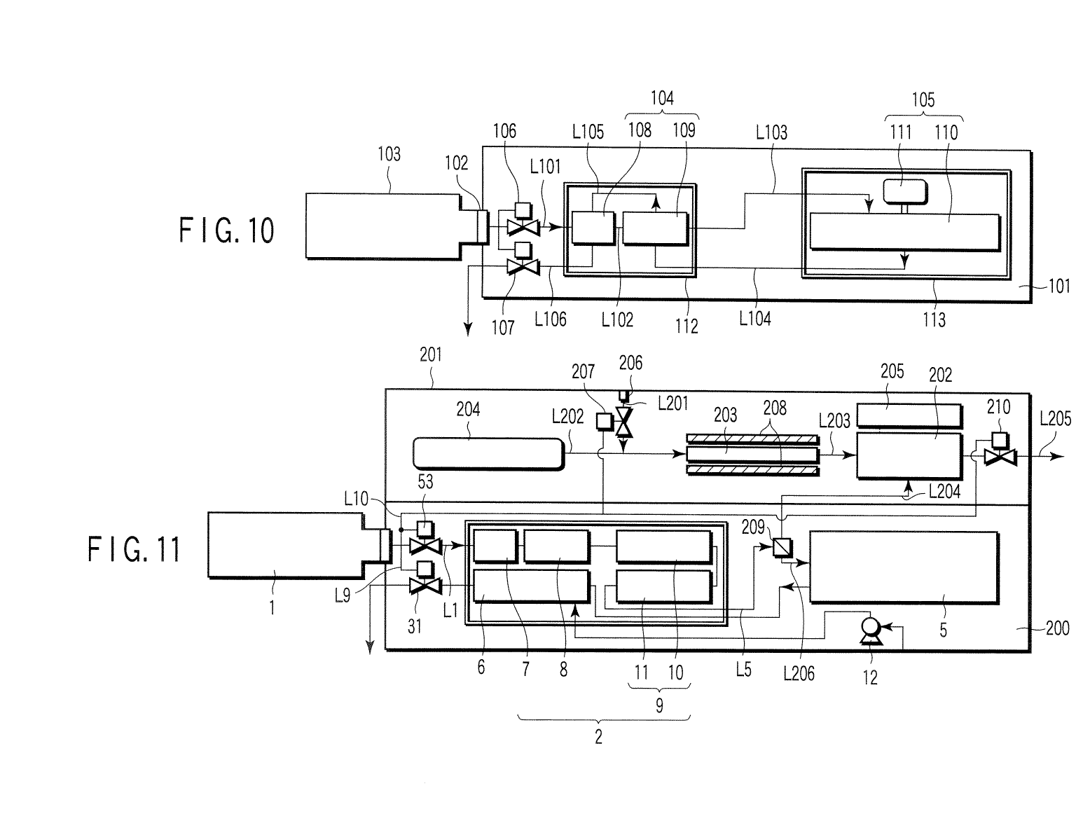

FIG. 10 shows a block diagram illustrating the construction of the modified ultramicro-gas turbine system according to an eighth embodiment of the present invention. This modified ultramicro-gas turbine system of this embodiment is equipped with a system main body 101, and with a fuel vessel 103 removably connected, via a connecting portion 102, with the system main body 101. This system main body 101 is equipped with a reformer 104, a reacting means 105, an inlet side cut-off valve 106, and an outlet side cut-off valve 107. The reformer 104 is constituted by a vaporizing section 108, and a reforming section 109. The reaction means 105 is constituted by an ultramicro-gas turbine 110, and a power generator 111.

The fuel vessel 103 is removably connected, via the connecting portion 102, with an inlet port line L101 communicated with the vaporizing section 108. The fuel vessel 103 is filled with, as a fuel for the modified ultramicro-gas turbine system, an organic raw material (fuel) having a higher saturated vapor pressure than atmospheric pressure. This fuel may be a mixture of dimethyl ether and water. The fuel vessel 103 may be formed of, for example, a pressure vessel equipped with a connecting portion which can be removably connected with the main body 101 of the modified ultramicro-gas turbine system. As for the kind of fuel and the method of feeding the fuel may be the same as that of the fuel cell systems explained in the above-described first to seventh embodiments.

The inlet side cut-off valve 106 is attached to the line L101 which is communicated with the vaporizing section 108. A fuel is delivered from the fuel vessel 103, via the inlet side cut-off valve 106, to the vaporizing section 108 which located on the downstream side and connected, via the line L101, with the fuel vessel 103. The fuel that has been transferred to the vaporizing section 108 is heated and vaporized. Due to the effects of the pressure of fuel which is higher than atmospheric pressure, the inlet side cut-off valve 106 is brought into an open state. As for the structure of the inlet side cut-off valve 106, it is possible to employ the same structure as that of the fuel cell systems explained in the above-described first to seventh embodiments.

This vaporizing section 108 is connected, via a pipe line L102, with the reforming section 109. The vaporized fuel that has been transferred to the reforming section 109 is reformed in the reforming section 109 into a gas containing hydrogen (reformed gas). As for the structure of the reforming section 109, it is possible to employ the same structure as that of the fuel cell systems explained in the above-described first to seventh embodiments.

The reforming section 109 is connected, via a line L103, with an ultramicro-gas turbine 110. As for the ultramicro-gas turbine 110, it is possible to employ those which can be manufactured by making use of MEMS (Micro Electro Mechanical System) techniques or mechanical working techniques. In this ultramicro-gas turbine 110, the hydrogen, etc. in the reforming gas is mixed with air that has been compressed by a compressor (not shown) to generate combustion, thereby driving the turbine to generate electric energy in the generator 111.

The exhaust gas discharged from the ultramicro-gas turbine 110 is introduced, via the line L104, into the reforming section 109 from which the exhaust gas is introduced, via the line L105, into the vaporizing section 108. Simultaneously, the heat of the exhaust gas is transmitted, though heat exchange, to the vaporizing section 108 and also to the reforming section 109, thus allowing the exhaust gas to cool.

From the viewpoint of heating efficiency, the vaporizing section 108 and the reforming section 109 are surrounded and covered by a heat-insulating member 112, while the ultramicro-gas turbine 110 and the generator 111 are surrounded and covered by a heat-insulating member 113.

The outlet side cut-off valve 107 is installed in the line L106 (outlet flow channel) constituted by piping, etc. for discharging exhaust gas from the reformer 104 to the outside of the fuel cell system. The exhaust gas thus cooled is permitted to pass through the outlet side cut-off valve 107 and discharged out of the modified ultramicro-gas turbine system. As for the structure of the outlet side cut-off valve 107, it is possible to employ the same structure as that of the fuel cell systems explained in the above-described first to seventh embodiments.

### Ninth Embodiment

Next, an analytical system according to the ninth embodiment of the present invention will be explained with reference to FIG. 11. Incidentally, with respect to the components or parts of this embodiment which overlap with those of the above-described embodiments, the explanations thereof will be omitted in the following description. The analytical system according to this embodiment is formed of a combination of the fuel cell system of FIG. 3 with an analyzing section, thus providing the fuel cell system with a function for using it as a portable analytical instrument. In FIG. 11, the inlet side cut-off valve shown therein is formed of the dividing-flow type cut-off valve 53 of FIG. 5. However, this inlet side cut-off valve may be formed of the single-flow type cut-off valve 4 of FIG. 3.

The analyzing section 201 comprises, in addition to a conventional hydrogen flame ionization detector (FID), a column 203, a carrier gas holding section 204 and an analytic control section 205. This analyzing section 201 is used for analyzing the gas to be measured (i.e. measuring gas).

The gas to be measured is fed from a measuring gas supply port 206 and introduced, via a line L201, into the column 203. In this line L201, there is disposed an inlet side cut-off valve 207 for the analyzing section. As for the structure of the inlet side cut-off valve 207 for the analyzing section, it is possible to employ the same dividing-flow type cut-off valve as employed in the fuel cell systems explained in the above-described first to seventh embodiments.

The measuring gas is introduced, via the inlet side cut-off valve 207, into a channel portion located on the upstream side of the column 203. The gas thus introduced is permitted to pass, together with a flow of an inert gas such as helium or nitrogen gas supplied from the carrier gas-holding section 204 through a line L202, through the column 203 which is heated by an electric heater, thereby isolating each gas component from others. As for the column 203, it is possible to employ the conventional capillary column or the conventional packed column.

The measuring gas thus isolated is fed, via the line L203, to FID 202 to be controlled by the analytic control section 205. On the other hand, the reformed gas passed through the methanation section 11 of the fuel cell system is introduced, via a line L5, into a hydrogen purification section 209, in which the reformed gas is processed so as to eliminate therefrom methane, carbon dioxide and water vapor, thus obtaining a high-concentration hydrogen gas. The high-concentration hydrogen gas thus obtained is fed, via a line L204, into the FID 202, in which the hydrogen gas is allowed to burn, thus ionizing the measuring gas.

As for the hydrogen purification section 209, it is possible to employ any known hydrogen permeable membrane such as a metallic membrane (palladium, vanadium or tantalum) or a hydrogen semipermeable membrane such as a quartz-based membrane.

The exhaust gas discharged from the FID 202 is then discharged, via the line L205, out of the system. An outlet side cut-off valve 210 for the analyzing section is installed in this line L205. The measuring gas which has been decomposed into carbon dioxide and water vapor in the FID 202 and also the gas containing water vapor generated from the combustion of the high-concentration hydrogen gas are discharged, through the outlet side cut-off valve 210, out of the system. As for the outlet side cut-off valve 210 for the analyzing section, it is possible to employ the same kind of dividing-flow type cut-off valve as employed in the fuel cell systems explained in the above-described first to seventh embodiments.

The reformed gas that has passed through the hydrogen purification section 209 is separated into the aforementioned high-concentration hydrogen gas and a low concentration hydrogen gas. In this case, the low concentration hydrogen gas is introduced, via a line L206, into the fuel cell unit 5, thereby enabling it to be used for the generation of electrical energy. The electric power thus generated can be used for driving the FID 202, the analytic control section 205, the electric heater 208, etc.

Incidentally, as for the means for heating the column 203, it may not necessarily be required to employ the electric heater 208 but a known heat pipe for example can be employed, thereby making it possible to feed part of the heat generated in the combustion device 6 of the fuel cell system to the column 203.

### Tenth Embodiment

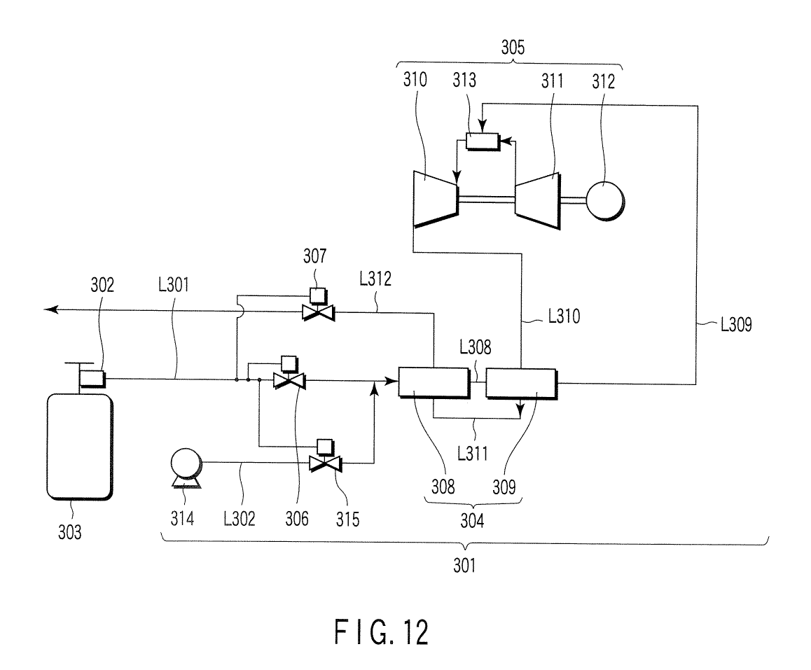

FIG. 12 shows a block diagram illustrating the construction of the modified gas turbine system according to a tenth embodiment of the present invention.

This modified gas turbine system of the tenth embodiment is equipped with a system main body 301, and with a dimethyl ether vessel 303 removably connected, via a connecting portion 302, with the system main body 301. This system main body 301 is equipped with a reformer 304, a reacting means 305, an inlet side cut-off valve 306, and an outlet side cut-off valve 307. The reformer 304 is constituted by a vaporizing section 308, and a reforming section 309. The reaction means 305 is constituted by a turbine 310, a compressor 311 mounted coaxially on the turbine 310, and a combustion device 313. A combination of the compressor 311, the combustion device 313 and the turbine 310 will be referred to as a gas turbine.

The dimethyl ether vessel 303 is removably connected, via the connecting portion 302, with a line L301 (inlet port flow channel) such as a piping, etc., which is communicated with the vaporizing section 308. The dimethyl ether vessel 303 is filled with liquefied dimethyl ether. This fuel vessel 303 may be formed of a pressure vessel. This pressure vessel is equipped with a connecting portion 312, thereby making it possible to removably connect this pressure vessel with the main body 301.

The liquefied dimethyl ether has a saturated vapor pressure (absolute pressure) of about 6 atm at ordinary temperature, which is higher than atmospheric pressure. As a result, by making the most of the pressure of dimethyl ether itself, dimethyl ether can be delivered from the vessel 303 to the vaporizing section 308. On this occasion, water is supplied from a water pump 314 installed in a line L302 to be combined with the line L301.

An inlet side cut-off valve 306 for DME is installed at a portion of the line L301 which is located on the downstream side of the connecting portion 302, this line L301 being communicated with the vaporizing section 308. Further, an inlet side cut-off valve 315 for water is installed at a portion of the line L302 which is located on the downstream side of the water pump 314, this line L302 being combined with the line L301. Dimethyl ether is permitted to pass through the inlet side cut-off valve 306 for DME, while water is permitted to pass through the inlet side cut-off valve 315 for water, thereby enabling the DME to combine with the water at a portion of the line L301 which is located on the downstream side of the cut-off valve 306, this mixed fuel being subsequently introduced into the vaporizing section 308. The mixed fuel thus introduced into the vaporizing section 308 is heated and vaporized in this vaporizing section 308. Due to the effect of the pressure of dimethyl ether having a higher pressure than atmospheric pressure on both of these cut-off valve 306 and 315, these cut-off valve 306 and 315 are brought into an opened state, respectively. As for these inlet side cut-off valves 306 and 315, it is possible to employ the same structure as that of the fuel cell systems explained in the above-described first to seventh embodiments.

This vaporizing section 308 is connected, via a line L308, with the reforming section 309. The vaporized fuel that has been transferred to the reforming section 309 is reformed in the reforming section 309 into a gas containing hydrogen (reformed gas). As for the structure of the reforming section 309, it is possible to employ the same structure as that of the fuel cell systems explained in the above-described first to seventh embodiments.

The reforming section 309 is connected, via a line L309, with the combustion device 313 of the gas turbine. This gas turbine is operated so as to drive the generator 312 coaxially mounted on the turbine 310. Due to the generation of electrical energy by this generator 312, it is possible to obtain an electric power of several MW. The turbine is driven as the hydrogen, etc. existing in the reformed gas and the air compressed by the compressor 311 are mixed with each other and caused to burn in the combustion device 313.

The exhaust gas discharged from the gas turbine is introduced, via the line L310, into the reforming section 309 from which the exhaust gas is introduced, via the line L311, into the vaporizing section 308. On the occasion, the heat of the exhaust gas is transmitted, though heat exchange, to the vaporizing section 308 and also to the reforming section 309, thus allowing the exhaust gas to cool.

The outlet side cut-off valve 307 is installed in the line L312 (outlet flow channel) constituted by a piping, etc. for discharging exhaust gas from the vaporizing section 308 to the outside of the fuel cell system. The exhaust gas thus cooled is permitted to pass through the outlet side cut-off valve 307 and discharged out of the modified gas turbine system. As for the structure of the outlet side cut-off valve 307, it is possible to employ the same structure as that of the fuel cell systems explained in the above-described first to seventh embodiments.

According to the present invention, it is possible to provide a chemical reactor and a fuel cell system, which are capable of inhibiting the leakage of unreacted gas as well as the leakage of a gas containing a by-product.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A chemical reactor comprising:
a vessel for housing an organic raw material having a higher saturated vapor pressure than atmospheric pressure;
a reformer for reforming at least a portion of the organic raw material into a reformed gas;
an inlet flow channel to which the vessel is removably attached, enabling the vessel to be communicated with the reformer; and
an inlet port side cut-off valve disposed in the inlet flow channel and designed to be brought into an open state as the vessel is attached, thus permitting the organic raw material to pass through the inlet flow channel, and brought into a closed state as the vessel is removed, thus cutting off the inlet flow channel.

2. The chemical reactor according to claim 1, which further comprises:
reaction means for chemically reacting the reformed gas;
an outlet flow channel for enabling to discharge an exhaust gas from the reaction means; and
an outlet side cut-off valve disposed in the outlet flow channel and designed to be brought into an open state as the vessel is attached, thus permitting the exhaust gas to pass through the outlet flow channel, and brought into a closed state as the vessel is removed, thus cutting off outlet flow channel.

3. A chemical reactor comprising:
a vessel for housing an organic raw material having a higher saturated vapor pressure than atmospheric pressure;
a reformer for reforming at least a portion of the organic raw material into a reformed gas;
an inlet flow channel to which the vessel is removably attached, enabling the vessel to be communicated with the reformer; and
an inlet port side cut-off valve disposed in the inlet flow channel and designed to be brought into an open state as the pressure in the inlet flow channel becomes higher than a predetermined pressure, thus permitting the organic raw material to pass through the inlet flow channel, and brought into a closed state as the pressure in the inlet flow channel becomes lower than said predetermined pressure, thus cutting off the inlet flow channel.

4. The chemical reactor according to claim 3, which further comprises:
reaction means for chemically reacting the reformed gas;
an outlet flow channel for enabling to discharge an exhaust gas from the reaction means; and
an outlet side cut-off valve disposed in the outlet flow channel and designed to be brought into an open state as the pressure in the outlet flow channel becomes higher than a predetermined pressure, thus permitting the exhaust gas to pass through the outlet flow channel, and brought into a closed state as the pressure in the outlet flow channel becomes lower than said predetermined pressure, thus cutting off the outlet flow channel.

5. The chemical reactor according to claim 2, wherein the outlet side cut-off valve is brought into an open state by a saturated vapor pressure of the organic raw material.

6. The chemical reactor according to claim 1, wherein the inlet side cut-off valve is brought into an open state by a saturated vapor pressure of the organic raw material.

7. The chemical reactor according to claim 2, which further comprises a supply flow channel for feeding the organic raw material to the outlet side cut-off valve from the vessel.

8. A fuel cell system comprising:
a vessel for housing an organic raw material having a higher saturated vapor pressure than atmospheric pressure;
a reformer for reforming at least a portion of the organic raw material into a reformed gas, the reformer comprising a vaporization section for vaporizing the organic raw material, a reforming section for reforming the organic raw material thus vaporized into a hydrogen-containing gas, and a carbon monoxide-removing section for removing at least a portion of carbon monoxide included in the hydrogen-containing gas;
an inlet flow channel to which the vessel is removably attached, enabling the vessel to be communicated with the reformer, the inlet flow channel being disposed on the inlet port side of the reformer;
a cut-off valve disposed in the inlet flow channel and designed to be brought into an open state as the vessel is attached, thus permitting the organic raw material to pass through the inlet flow channel, and brought into a closed state as the vessel is removed, thus cutting off inlet flow channel;
a fuel cell unit for generating electrical energy by making use of the hydrogen-containing gas having said at least a portion of carbon monoxide removed therefrom and air including oxygen; and
a combustion device for burning at least a portion of exhaust gas discharged from the fuel cell unit.

9. The chemical reactor according to claim 8, which further comprises:
an outlet flow channel for enabling to discharge a combustion exhaust gas from the combustion means; and
an outlet side cut-off valve disposed in the outlet flow channel and designed to be brought into an open state as the vessel is attached, thus permitting the combustion exhaust gas to pass through the outlet flow channel, and brought into a closed state as the vessel is removed, thus cutting off the outlet flow channel

10. A fuel cell system comprising:
a vessel for housing an organic raw material having a higher saturated vapor pressure than atmospheric pressure;
a reformer constituted by a vaporization section for vaporizing the organic raw material, by a reforming section for reforming the organic raw material thus vaporized into a hydrogen-containing gas, and by a carbon monoxide-removing section for removing at least a portion of carbon monoxide included in the hydrogen-containing gas;
an inlet flow channel to which the vessel is removably attached, enabling the vessel to be communicated with the reformer;
a cut-off valve disposed in the inlet flow channel and designed to be brought into an open state as the pressure in the inlet flow channel becomes higher than a predetermined pressure, thus permitting the organic raw material to pass through the inlet flow channel, and brought into a closed state as the pressure in the inlet flow channel becomes lower than said predetermined pressure, thus cutting off the inlet flow channel;
a fuel cell unit for generating electrical energy by making use of the hydrogen-containing gas having said at least a portion of carbon monoxide removed therefrom and air including oxygen; and
a combustion device for burning at least a portion of exhaust gas discharged from the fuel cell unit.

11. The chemical reactor according to claim 10, which further comprises:
an outlet flow channel for enabling to discharge a combustion exhaust gas from the combustion means; and
an outlet side cut-off valve disposed in the outlet flow channel and designed to be brought into an open state as the pressure in the outlet flow channel becomes the higher than a predetermined pressure, thus permitting the combustion exhaust gas to pass through the outlet flow channel, and brought into a closed state as the pressure in the outlet flow channel becomes lower than said predetermined pressure, thus cutting off the outlet flow channel;

12. The chemical reactor according to claim 8, which further comprises a heat-insulating member for covering the combustion means and at least one of the vaporization section and the reforming section.
